(19) United States
(12) Patent Application Publication
(10) Pub. No.: US 2013/0262315 A1
(43) Pub. Date: Oct. 3, 2013

(54) System for Secure Purchases Made by Scanning Barcode Using a Registered Mobile Phone Application Linked to a Consumer-Merchant Closed Loop Financial Proxy Account System

(71) Applicant: John Hruska, Stuart, FL (US)

(72) Inventor: John Hruska, Stuart, FL (US)

(21) Appl. No.: 13/436,549

(22) Filed: Mar. 30, 2012

(51) Int. Cl. G06Q 20/40; G06Q 30/02

(52) U.S. Cl. 705/67

(57) ABSTRACT

A secure product purchasing system and method are disclosed to allow for online purchase of goods or services by means of a proprietary graphical or barcode-represented printed or on-line digital product code and details to be either sent to or discovered by a customer, so as to be scanned then paid for using a secure financial closed-loop proxy account and a pre-registered personal handheld mobile device where all funds within the account remain in an “inactive” non-usable state until activated and allocated only by the customer through the mobile handheld device, wherein the merchant is registered to the secure financial closed-loop proxy account.

### FIELD OF THE INVENTION

With the increasing security risks associated with using personal financial information for on-line payments specifically at a shopping cart level during on-line checkout the following describes innovated process, a method and system for secure on-line e-commerce purchases made by scanning (reading) the participating retailer's product barcode and using a financial-linked registered smart phone mobile device with mobile wallet application registered to a consumer-merchant closed-loop financial proxy escrow account and by creating a unique time-sensitive single-use transactional code against the consumer funds using a secure registered mobile application over a secure telecommunication network.

### SUMMARY OF THE INVENTION

The use of mobile smart phone is increasingly becoming more prevalent. At the same time the risk of stolen Credit Card data and identity theft continues to cost the industry billions of dollars in losses to both consumers and merchants. A secure mobile smart phone transactional system within a closed loop consumer-merchant financial proxy system can be established and is described providing for secure payment process without the need for an e-commerce shopping cart, needing to provide any personal information or financial account information being exposed over the internet. Both merchants and consumers sign up and register to the secure closed loop financial proxy account and back-end mobile wallet system services. E-Commerce merchants display product information and an URL encoding the SKU# and merchant ID within a graphic (e.g. a QR code) and display this on their e-commerce website or within a social networking website alongside the picture of the product to be purchased. The merchant's inventory information is accessed through the mobile wallet system's back end APIs allowing merchant's merchandise data to be obtained by the mobile money wallet service provider's backend acquiring: product URL comprising the Product SKU#, address location, description, picture, price/unit quantity, merchant and product identifying details. A standard purchasing code (e.g. QR Code) is created by the merchant identifying the merchant, and the product URL which includes sku# and is displayed along with the product of interest on their website without the need of a shopping cart. In Addition, this can also be displayed and scanned from any digital or print media including websites, social networks and high-def television screens. Consumers use the financial-linked mobile wallet application to scan the product QR code using the device's camera allowing them to securely link to their mobile wallet financial account, to approve and make a purchase without the need of check out through an e-commerce shopping cart nor give out any personal or financial information (debit/credit card info). Consumers and Merchants will both have a unique and novel opportunity to transact business securely using code purchasing within a closed loop mobile wallet environment protecting the consumer and the merchant from fraudulent activity related to identity theft and credit card theft.

### BRIEF DESCRIPTION OF THE DRAWINGS

FIG. 1 shows the Description of WiGime Scan and Buy™

FIG. 2 shows the Schematic of Phone Barcode Purchasing From Scan and Buy™ Ad

### DETAILED DESCRIPTION

Merchants and consumers will sign up and register to a closed loop mobile wallet financial proxy payment service allowing them to transact business securely through mobile smart phone secure telecommunication network. Consumers download the mobile money wallet application, create an account, and register their mobile device to their account thereby creating a secure mobile money financial proxy account between the smart phone device, the device application, the individual and the proxy account in order to transact business. Within the same closed loop environment merchants sign up and establish an account creating a secure closed-loop financial proxy environment account through the mobile money wallet service provider. Once the merchant is registered and verified by the mobile money service provider, access to the merchant's product inventory is provided through an application program interface (API). Detailed information from the merchant's inventory database is obtained by the mobile wallet service provider's backend including: Merchant Identifier, product identifiers (SKU# or other industry standards), pictures, description, price, price/unit, lowest price, and number of units currently available. The merchant or service providers backend creates graphical representation of the data in the form of a barcode (e.g. QR code) used for product description to include the merchant identifier, a product identifier SKU# and product URL locator.

The consumer member sees the advertisement of the product with the merchant's barcode (QR code) in a merchant's brick and mortar store, on the merchant's e-commerce website, as an advertisement in a search engine or a social networking website (or in an on-line advertisement, in the newspaper, printed catalogue or on television). Using the mobile wallet application on the registered mobile smart phone device the consumers logs in and is authenticated. Once user is authenticated is allowed access to their proprietary funded financial proxy account and selects the WiGime Scan and Buy™ service feature within the mobile wallet application and scans the product QR code displayed mobile smart phone's camera and the intent to make a secure purchase of the item. The mobile application will: 1) scan and decode the code; 2) sends the decoded string over a secure telecommunication network to the mobile money wallet service provider's backend; 3) the backend verifies it is a valid Merchant within the backend Database of Merchants; 4) verifies it is a Merchant authorized to use the Scan and Buy service and 5) obtains the SKU# information and gets the product information from the merchant's database along with inventory status, total price, delivery date.

### Mobile Money Wallet Service Provider Back End

The mobile wallet service provider's back end after verifying the merchant, through a merchant application protocol interface (API) call through internet protocol sends a request to the merchant's back-end for that specific product using the SKU# identifier, and the consumer's zip code requesting a Price check, Quantity in stock, Shipping Price and total price (if taxes apply). The Merchant's back-end sends back the details response to the mobile wallet service provider's backend and subsequently passes the details to the consumer's mobile application using a secure ssl encrypted telecommunication data network. The consumer is shown: 1) the product details, 2) a picture along with an Action “Buy Now” button option, a bookmark and save button option and 3) a quantity, and 4) total pricing including shipping and applicable taxes. The mobile wallet back-end application stores inventory available so can limit quantity ordered and can also can limit maximum order dollar amount.

The consumer selects the Action “Buy” button to purchase the item; the backend calculates the total purchase price including delivery charge and delivery date. The total purchase price is compared to the consumer's effective current balance available within their mobile wallet financial proxy account to process the purchase. If the correct amount is in the consumer's financial proxy mobile wallet account then a confirmation page with delivery date, a total purchase price, sales tax and optionally a delivery address change request with confirmation is sent to the consumer's mobile application for confirmation and purchase. Once confirmation is selected the backend creates a unique time sensitive, single use transactional code (aka WiGime Payment Code™ for the mobile wallet system WiGime™) against the available funds within the consumer's mobile money services account and using the unique time-sensitive transactional code the funds are debited from the consumer's account for the exact total amount from the effective available balance and are held in a time sensitive state pending the merchant shipping the product. The pending unique time sensitive WiGime Payment Code is sent over an ssl network connection to the merchant back end for verification and proof of payment along with (a) Purchase Date, (b) Product SKU, (c) Total Quantity and total Purchase Price, (d) Shipping Address, (e) Customer Information (such as Name, Mobile Number, email address), along with customer's cell phone information. The Merchant confirms WiGime Payment Code™ is valid and initializes processing the order using industry standard order processing placing the order in a pending status. The mobile money service backend and consumer receives pending order update message along with an Order number and estimated delivery date. This along with instructions on how to view order status, and cancel order before it ships etc. along with order #, email and phone of merchant are passed on to the consumer's e-mail and is displayed within the consumer's mobile wallet money service provider account. After a certain amount of time pending the merchant decides to process the order and sends a process ordering information update to the consumer and mobile money service backend. Simultaneously the merchant once again checks the mobile wallet money service backend for the validity of the transactional WiGime Payment Code™ for both value and expiration; and if valid proceeds to redeem the WiGime Payment Code™ and then ships the product to the consumer. The Merchant's backend notifies mobile wallet money service backend and the consumer that the product has been shipped. From within the mobile wallet money service account the consumer's time sensitive WiGime Payment Code™ is redeemed by the merchant and the value gets credited to the merchant's account balance with the total purchase amount minus any mobile wallet money service processing fees and debited from the consumer's available account balance. Both the Consumer's and Merchant's message center and history get updated within the mobile wallet money service account to reflect transaction.

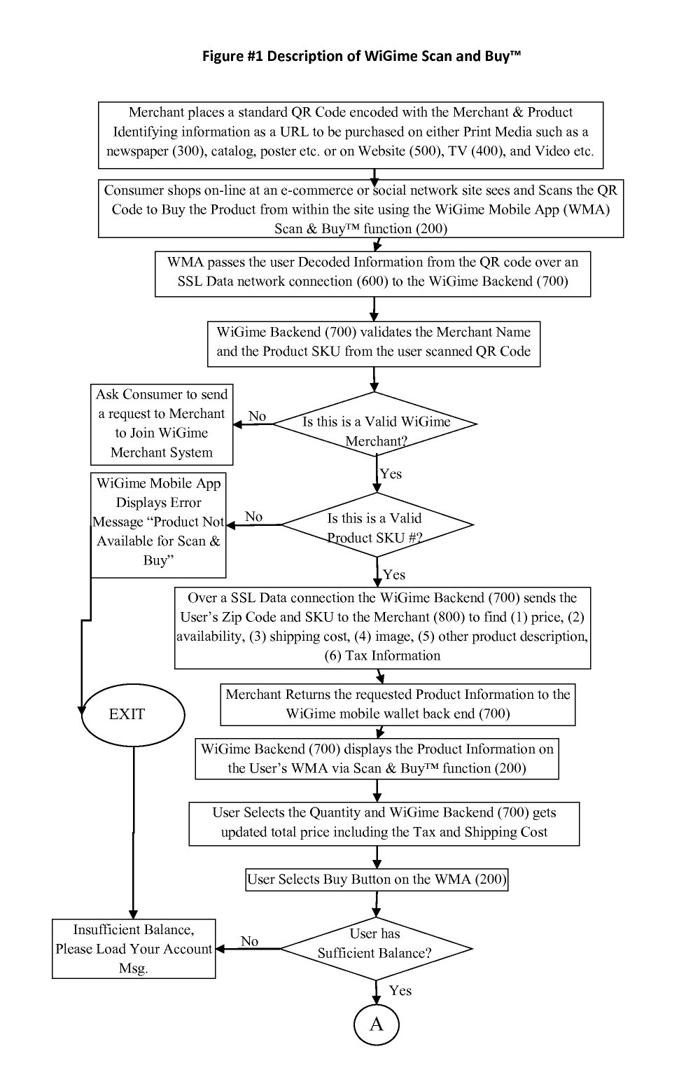

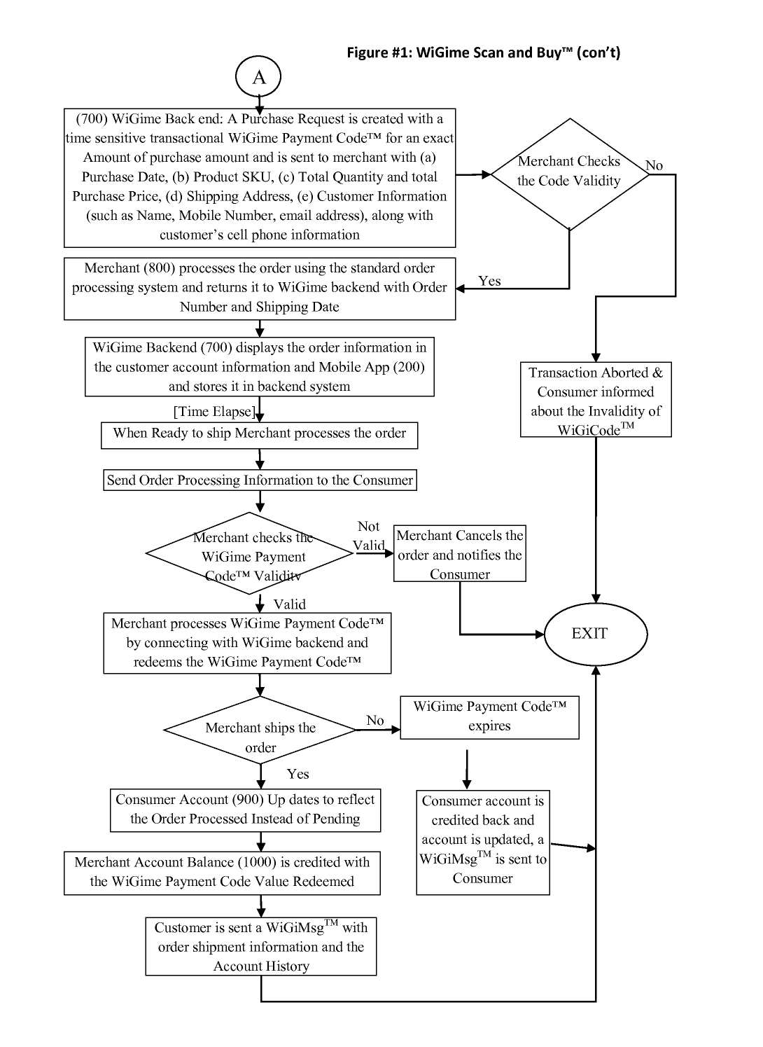

### FIG. 1 Description of WiGime Scan and Buy™

100: A Registered Mobile Phone with a data plan internet connection and a barcode reader registered to A Financial Mobile Proxy Service—Mobile Money Service

200: Mobile Money Service Client Application securely connected to the Financial Proxy service via the Registered Mobile Phone

300: A Merchant Retailer Print Ad with a Barcode (QR code or similar) Encoding a URL containing the Merchant Identifier and Product Identifier (such as SKU#) and Mobile Money Service Identifier

400: A Merchant Retailer Television Ad with a Barcode (QR code or similar) Encoding a URL containing the Merchant Identifier and Product Identifier (such as SKU#) and Mobile Money Service Identifier

500: A Merchant Retailer or social networking Website Ad (electronic digital Ad) with a Barcode (QR code or similar) Encoding a URL containing the Merchant Identifier and Product Identifier (such as SKU#) and Mobile Money Service Identifier

600: SSL Telecommunication internet connection which securely connects Mobile Phone client to the Financial Proxy Account/Mobile Money Service

700: Financial Mobile Money Proxy Account Service (WiGime) Back end with both the registered User and registered merchants responsible for order placement, transactional code (WiGiCode™) generation, and processing and reconciliation.

800:vA registered Retail Merchant with the mobile money service who has product inventory data and barcodes, created encoding a URL containing the specific product inventory (SKU#), a merchant Identifier listed and stored in the Mobile Money Service's Backend.

900: Consumer's Financial Mobile Money Proxy Account Service (WiGime) with both the Mobile Phone and the User registered and funds present within their proxy financial account which the phone is registered to.

1000: Merchant's Financial Mobile Money Proxy Account (WiGime).

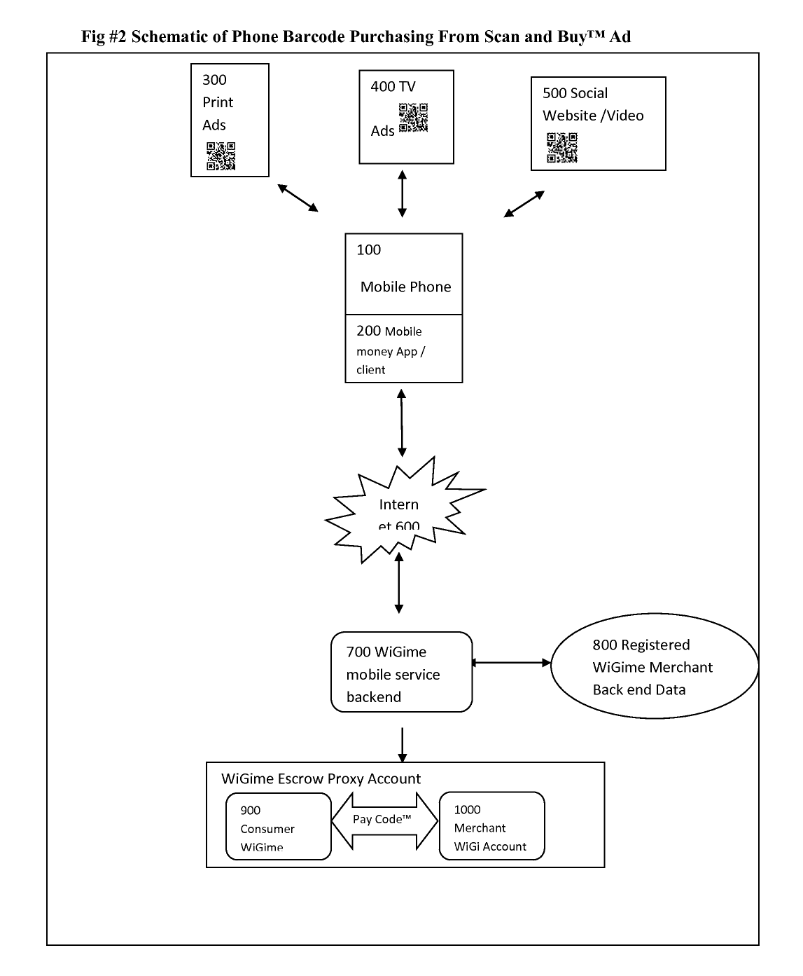

### Description of Process in FIG. 2

The registered user using his registered smart phone device (100) opens the mobile money service application (200) and logs in with personal credentials. The User would like to make a purchase from a print Ad (300), a television Ad (400) or any digital (website or billboard Ad: 500) and selects the Scan and Buy feature within the application with the intent to purchase the item from the advertisement. The application reads and decrypts the Barcode information. Over a secure SSL data connection (600) the decoded information gets passed to the mobile money service's backend system (700). The Domain name (Merchant ID) and product SKU# is validated in the mobile money service's backend merchant-product data tables. Once confirmed and a buy order is selected and confirmed by the user a WiGime Payment Code™ is generated for the purchase price and the order information is passed to the merchant (800) and once confirmed it has been shipped the merchant's WiGime Payment Code™ is redeemed by merchant, their account (1000) is credited and consumer's account is debited (900).

I claim:

1. A system on a computer based network for a secure purchase of a product by a customer from a merchant by means of the customer's pre-registered personal mobile device, comprising:
a registration protocol for the personal mobile device;
a point of purchase mobile application installed on the personal mobile device, which provides a mechanism for the customer to log in and be authenticated, and which utilizes a scanning device on the personal mobile device to scan and decode a product advertisement, information and price expressed as a graphical image, which is received by the customer from a variety of digital and print media to identify the merchant and the product subject matter;
an activation protocol for identifying the account's registered mobile device, using a unique authentication identification number specific to the personal mobile device, the mobile application installed on that device, and the customer, in order to make the account and funds active to purchase a specific product by the customer from a specific merchant;
a secure financial proxy account such as an online wallet, established for the purpose of holding unused dormant funds of the customer pooled together with funds of the merchant or financial institution until the customer activates and allocates their funds by means of their registered personal mobile device and mobile application;
a product detail and pricing generating system which is registered with and identifies the product and merchant to the mobile application;
a transactional and authentication server which stores and authenticates data sent from the customer's personal mobile device and mobile application over a telecommunications network;
a first proprietary application resident on the transactional and authentication server using customer-based information to validate the specific customer and device, the specific merchant, and the specific product that the customer wishes to purchase from that merchant; and
a second proprietary application resident on the transactional and authentication server which creates a unique customer and device specific, time-sensitive, single-use encrypted digital transactional alphanumeric token which is specific to the personal mobile device, its location, and the customer's personal identification information, the specific product and the specific merchant.

2. The system of claim 1, further comprising:
a proprietary merchant product integration application which reads merchant proprietarily formatted product information scanned and decoded from the graphical image and validated by the first proprietary application and then places this in a format compatible with the second proprietary application, and wherein the digital and print media is from the group comprising emails, websites, social media, banners, newspaper and magazine ads, posters, and billboards.

3. The system of claim 1, wherein the a product advertisement, information and price may be simultaneously scanned and decoded from the graphical image at the customer's or the merchant's end to identify the subject matter for the invoice and thus ensure data redundancy, integrity and security.

4. The system of claim 1, incorporating logical rules to set an alarm for the customer and merchant if the product price exceeds the available funds in the proxy account so that the customer may replenish funds.

5. The system of claim 1, wherein the data is sent from the customer's personal mobile device and mobile application to the transactional and authentication server over a telecommunications network by means of an ssl or other secure protocol.

6. The system of claim 1, wherein the unique customer and device specific, time-sensitive, single-use encrypted digital transactional alphanumeric token is created by the transactional and authentication server as soon as the customer authorizes a credit and redeemed by the merchant as soon as the product is shipped to the customer, where a credit to the merchant's secure financial proxy account, and a debit to the customer's secure financial proxy account occur simultaneously.

7. The system of claim 1, wherein a transactional history is recorded for accounts of the customer and merchant.

8. The system of claim 1, wherein the customer receives a product advertisement, information and price from a merchant via mail/email with a unique bar code, and a complex symbol to be used to settle the amount due for purchase of the product.

9. The system of claim 1, wherein the customer ensures secure purchases of a given a product at a known price on a separate dedicated system created account purely for the purpose of the purchase and replenishes funds in this account at intervals based on anticipated regular purchases.

10. The system of claim 1, compatible with the strong encryption standards of existing financial systems, and wherein the unique customer and device specific, time-sensitive, single-use encrypted digital transactional alphanumeric token is never duplicated and contains no permanent account information of the customer.

11. A method for network for secure purchase by a customer of a product from a merchant by means of the customer's personal mobile device, comprising the steps of:
establishing a secure financial proxy account such as an online wallet, for the purpose of holding unused dormant funds of the customer pooled together with funds of the merchant, until such time that the customer activates and allocates the unused dormant funds by means of a registered personal mobile device of the customer and a mobile application installed on the personal mobile device;
linking the secure financial proxy account to a transactional and authentication server, upon which resides an application to effectuate secure purchase of the product by the customer from the merchant;
scanning a product advertisement, information and price, which was received by the customer from a variety of digital and print media expressed as a graphical image, by means of a scanning device on the personal mobile device;
validating the customer by allowing the customer to log in to their mobile application installed on their personal mobile device, then comparing to information for the customer stored on a database of the merchant:
passing customer and merchant information retrieved at the time of validating to the transactional and authentication server along with the scanned product advertisement, information and price;
decoding the scanned product advertisement, information and price by means of the mobile application installed on the personal mobile device in order to identify the merchant and product;
generating a unique customer and device specific, time-sensitive, single-use encrypted digital transactional alphanumeric token by the transactional and authentication server using the unique identifier of the specific personal mobile device, the unique identifier of the mobile application installed on the personal mobile device, the customer's personal identification information, the customer's specific product advertisement, information and price, and the specific merchant, for the purpose of making payment for the paying the particular product to the specific merchant;
transmitting over a telecommunication network the customer's information and the unique user and device specific, time-sensitive, single-use encrypted digital transactional alphanumeric token by a secure protocol over a telecommunications network from the transactional and authentication server to the merchant;
verifying by the merchant of the customer's information, the product advertisement, information and price, and the unique user and device specific, time-sensitive, single-use encrypted digital transactional alphanumeric token;
shipping of the product to the customer by the merchant;
redeeming, upon shipping of the product to the customer by the merchant of the unique customer and device specific, time-sensitive, single-use encrypted digital transactional alphanumeric token, upon verifying the token and the customer's information, in order to transfer the customer's activated funds to the account of the merchant.

12. The system of claim 11, further comprising the step of:
reading at the transactional and authentication server, by means of an integration application, merchant proprietarily formatted product advertisement, information and price scanned decoded and validated from the graphical image; and
placing this product advertisement, information and price in a format compatible with the second proprietary application; and (let's discuss)
wherein the digital and print media is from the group comprising emails, websites, social media, banners, newspaper and magazine ads, posters, and billboards.

13. The method of claim 11, wherein the steps of scanning the product advertisement, information and price expressed as a graphical image and the step of decoding the scanned product advertisement, information and price to identify the merchant and product are carried out simultaneously at the customer's and the merchant's end to ensure data redundancy, integrity and security.

14. The method of claim 11, further comprising the steps of:
logically checking if the product price exceeds the available funds in the proxy account so that the customer may replenish funds; and
generating an alarm for the customer if the product price exceeds the available funds in the proxy account so that the customer may replenish funds.

15. The method of claim 11, wherein the secure protocol in the transmitting step is an ssl.

16. The method of claim 11, wherein the step of generating the unique customer and device specific, time-sensitive, single-use encrypted digital transactional alphanumeric token is created by the transactional and authentication server occurs as soon as the customer authorizes a credit and the step of redeeming of the unique customer and device specific, time-sensitive, single-use encrypted digital transactional alphanumeric token by the merchant immediately after the step of shipping the product to the customer, where a credit to the merchant's secure financial proxy account, and a debit to the customer's secure financial proxy account occur simultaneously

17. The method of claim 11, further comprising the step of recording a transactional history for the accounts of the customer and merchant.

18. The method of claim 11, wherein the customer receives a product advertisement, information and price from a merchant via mail or email and the graphical image consists of a unique bar code, and a complex symbol to be used to settle the amount due for the product purchase price.

19. The method of claim 11, wherein the customer ensures the secure payment for a product on a separate dedicated system account created purely for the purpose of the payment, and replenishes funds in this account at intervals and by increments based on anticipated regular purchases.

20. The method of claim 11, compatible with the strong encryption standards of existing financial systems, and wherein the unique customer and device specific, time-sensitive, single-use encrypted digital transactional alphanumeric token is never duplicated and contains no permanent account information of the customer.
